(19) United States
(12) Patent Application Publication
(10) Pub. No.: US 2014/0122863 A1
(43) Pub. Date: May 1, 2014

(54) ACTIVITY ENABLED ACCESS

(71) Applicant: Zachary J. Prager, San Diego, CA (US)

(72) Inventor: Zachary J. Prager, San Diego, CA (US)

(21) Appl. No.: 14/069,715

(22) Filed: Nov. 1, 2013

Related U.S. Application Data
(60) Provisional application No. 61/721,400, filed on Nov. 1, 2012.

(51) Int. Cl. G06F 9/44

(52) U.S. Cl. CPC G06F 9/4421
USPC 713/100

(57) ABSTRACT

For activity enabled access, a method creates a schedule of a scheduled time that a physical condition is to be completed by a user. The method further measures the physical condition and sets a lock that prevents access to functionality at the scheduled time in response to the physical condition not exceeding a physical threshold. The method further releases the lock in response to the physical condition exceeding the physical threshold by the scheduled time.

### CROSS-REFERENCE TO RELATED APPLICATIONS

This application claims priority to U.S. Provisional Patent Application No. 61/721,400 entitled “ACTIVITY ENABLED ACCESS” and filed on Nov. 1, 2012 for Zachary J. Prager which is incorporated herein by reference.

### BACKGROUND

1. Field

The subject matter disclosed herein relates to access and more particularly relates to activity enabled access.

2. Description of the Related Art

It is widely known that physical activity promotes better health. However, the motivation to engage in physical activity and other beneficial activities is often lacking.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of an access system;

FIG. 1B is a schematic block diagram illustrating one alternate embodiment of an access system;

FIG. 1C is a schematic block diagram illustrating one alternate embodiment of an access system;

FIG. 1D is a schematic block diagram illustrating one alternate embodiment of an access system;

FIG. 2 is a drawing illustrating one embodiments of computing devices;

FIG. 3A is a drawing illustrating one embodiment of an access system;

FIG. 3B is a drawing illustrating one alternate embodiment of an access system;

FIG. 4A is a drawing illustrating one embodiment of a physical condition dialog window;

FIG. 4B is a drawing illustrating one embodiment of a device dialog window;

FIG. 4C is a drawing illustrating one embodiment of a functionality dialog window;

FIG. 5A is a drawing illustrating one embodiment of a schedule;

FIG. 5B is a drawing illustrating one alternate embodiment of a schedule;

FIG. 5C is a drawing illustrating one alternate embodiment of a schedule;

FIG. 6A is a schematic block diagram illustrating one embodiment of the schedule data store;

FIG. 6B is a schematic block diagram illustrating one embodiment of physical condition entries;

FIG. 6C is a schematic block diagram illustrating one embodiment of a device data store;

FIG. 6D is a schematic block diagram illustrating one embodiment of a functionality data store;

FIG. 7 a schematic block diagram illustrating one embodiment of a computing device; and

FIG. 8 is a schematic flow chart diagram illustrating one embodiment of an access method.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a non-transitory computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

The description of elements in each figure may refer to elements of proceeding figures. Like numbers refer to like elements in all figures, including alternate embodiments of like elements.

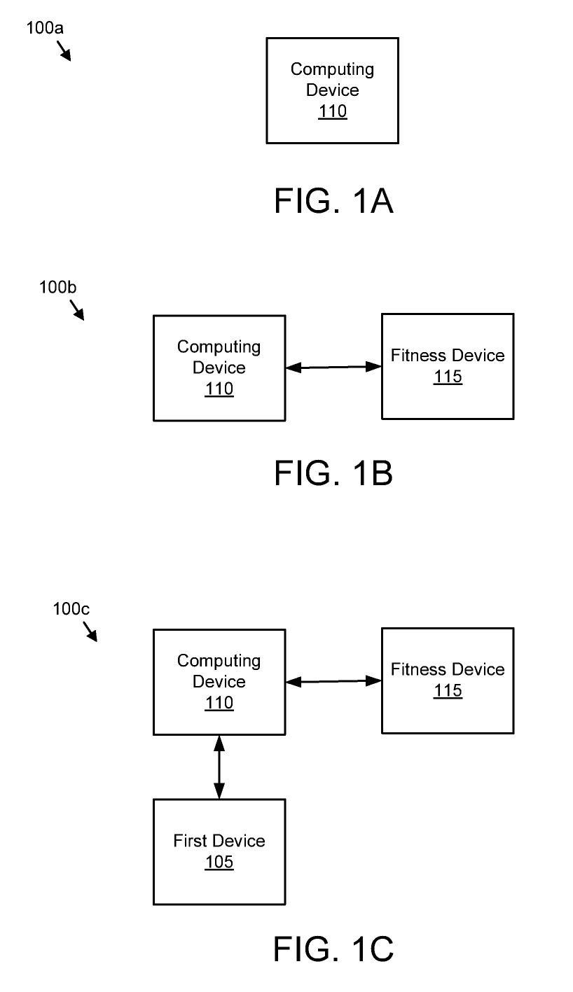

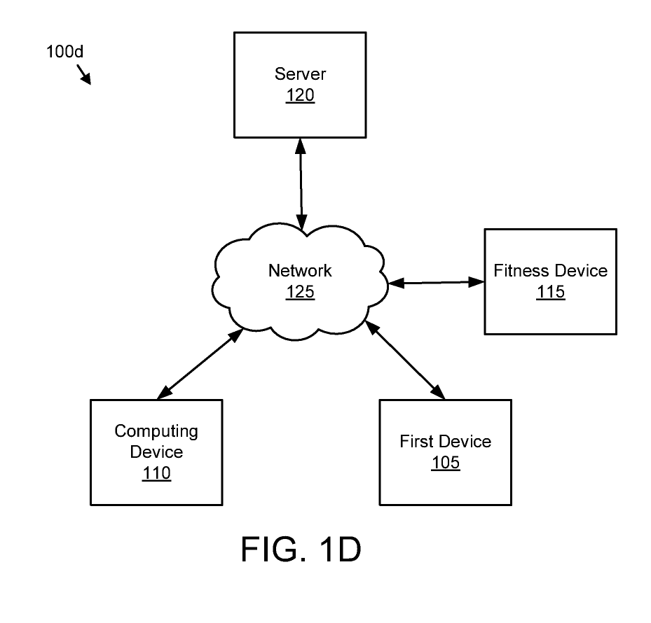

FIG. 1A is a schematic block diagram illustrating one embodiment of an access system 100a. The system 100a includes a computing device 110. In one embodiment, the computing device 110 includes one or more of an accelerometer, a global positioning system (GPS), a gyroscope, a camera, and a microphone.

The computing device 110 may create a schedule of scheduled times that a physical condition is to be completed. The physical condition may be completed by a user. The computing device 110 may measure the physical condition.

In addition, a lock may be set to prevent access to functionality. The functionality may be functionality of the computing device 110. The functionality may be an application, an operating system, physical access to the computing device 110, a logical access, and use of a payment instrument. The application may be a stand-alone software application, a script that executes when hypertext is parsed, or the like. The operating system may include access to the operating system, access to a function of the operating system, access to files within the operating system, access to an application executing on the operating system, or the like.

The logical access may be an access to a Universal Resource Locator (URL). For example, the logical access may be access to the URL for a social media account, an online game, an online news site, an Internet media channel, and the like. Alternatively, the logical access may be in access to a mobile telephone, a texting application, a chat application, a media provider, and the like. Further, the lock on the functionality of the computing device 110 may be released in response to the physical condition exceeding a physical threshold as will be described hereafter.

A user may communicate with the computing device 110 through a touchscreen, a keyboard, a pointing device, the microphone, the camera, or the like. In addition, the computing device 110 may communicate information and data to the user through the touchscreen, a speaker, and the like.

FIG. 1B is a schematic block diagram illustrating one alternate embodiment of an access system 100b. The computing device 110 of FIG. 1A is depicted in communication with a fitness device 115. The fitness device 115 may one or more of a shoe, a bicycle speedometer, a treadmill, a stationary bicycle, an elliptical trainer, a weight machine, a fitness class, a swim lap counter, a heart rate monitor, a global positioning system, a pedometer, and a biometric sensor. The fitness device 110 may measure the physical condition.

The computing device 110 may communicate with the fitness device 115 through a wireless connection. Alternatively, the computing device 110 may communicate with the fitness device 115 through a wired connection. For example, the computing device 110 may communicate with the fitness device 115 through universal serious bus (USB) connection.

The wireless connection may be a mobile telephone network. The wireless connection may also employ a WiFi network based on any one of the Institute of Electrical and Electronics Engineers (IEEE) 802.11 standards. Alternatively, the wireless connection may be a BLUETOOTH® connection as defined by the Bluetooth Special Interest Group. In addition the wireless connection may employ a Radio Frequency Identification (RFID) communication including RFID standards established by the International Organization for Standardization (ISO), the International Electrotechnical Commission (IEC), the American Society for Testing and Materials (ASTM), the DASH? Alliance, and EPCGlobal.

Alternatively, the wireless connection may employ a ZigBee connection based on the IEEE 802 standard. In one embodiment, the wireless connection employs a Z-Wave connection as designed by Sigma Designs. Alternatively, the wireless connection may employ an ANT and/or ANT+connection as defined by Dynastream Innovations Inc. of Cochrane, Canada.

The wireless connection may be an infrared connection including connections conforming at least to the Infrared Physical Layer Specification (IrPHY) as defined by the Infrared Data Association (IrDA). Alternatively, the wireless connection may be a cellular telephone network communication. All standards and/or connection types include the latest version and revision of the standard and/or connection type as of the filing date of this application.

FIG. 1C is a schematic block diagram illustrating one alternate embodiment of an access system 100c. The system 100c includes the computing device 110, a first device 105, and the fitness device 115. The computing device 110, the first device 105, and the fitness device 115 may communicate wirelessly over one or more wireless connections and/or over wired connections.

In one embodiment, the first device 105 is embodied within the computing device 110. Alternatively, the first device 105 may be separate and distinct from the computing device 110. The first device 105 may be the computing device 110, a power outlet, a network connection, a game console, a media player, and a physical lock, and the like.

The first device 105 may have functionality. The functionality may be an application, an operating system, a device activation, physical access to the first device 105, a logical access, and use of a payment instrument. The application may be a stand-alone software application, a script that executes when hypertext is parsed, or the like. The operating system may include access to the operating system, access to a function of the operating system, access to files within the operating system, access to an application executing on the operating system, or the like.

The device activation may include an ability to power on the first device 105, an ability to operate the first device 105, an ability to operate specified features of the first device 105, or the like. The physical access may include the ability to open a door or cabinet, physical access to an automobile, activating an automobile ignition, access to a power socket, access to a power cord, or the like.

For example, the functionality may be a game application that executes on a mobile telephone computing device 110. Alternatively, the functionality may be Internet access on the first device 105. In addition, the functionality may be physical access to a power cord for game console.

In one embodiment, the functionality is use of a payment instrument. The payment instrument may be an electronic wallet, a bank account, a prepaid card, a debit card, an online account, a gift card, an electronic credit account, or the like. For example, the payment instrument may be an electronic wallet embodied in a mobile telephone computing device 110. The logical access may be an access to a Universal Resource Locator (URL).

A lock may be set that prevents access to the functionality. For example, the lock may prevent virtual access to the game application. Alternatively, the lock may be a physical lock on the door, cabinet, or power cord. In another example, the lock may prevent access to the Internet. In another embodiment, the lock may prevent the activation of the first device 105 and/or the computing device 110. Alternatively, the lock may prevent operation of the first device 105 and/or the computing device 110.

The lock may prevent access to an application, operating system, or the like by one of preventing the application or operating system from loading or preventing the application or operating system from executing. The lock may prevent access to the device activation by preventing powering on the first device 105, preventing operating the first device 105, or preventing the operation of specified features of the first device 105.

In one embodiment, the lock may prevent use of the payment instrument. For example, the lock may prevent the use of an electronic wallet. Alternatively, the lock may prevent use of the payment instrument for selected types of purchases. For example, the lock may prevent the use of the payment instrument for purchasing food and/or beverages. However, the lock may allow the use of the payment instrument for gasoline, transportation, and the like.

In one embodiment, the fitness device 115 measures a physical condition. The physical condition may be a physical activity. The physical activity may be a motion, an activity on the fitness device 115, and an entrance to a fitness facility. The fitness device 115 may be a shoe, a bicycle speedometer, a treadmill, a stationary bicycle, an elliptical trainer, a weight machine, a fitness class, a swim lap counter, a heart rate monitor, a global positioning system, a pedometer, and a biometric sensor.

The fitness device 115 may measure the physical activity and communicate the physical activity to the computing device 110. Alternatively, the physical activity may be measured at the first device 105 with a lock preventing access to the functionality on the first device 105.

For example, the physical activity may be steps measured by a shoe or a pedometer. Alternatively, the physical activity may be motion measured with the bicycle speedometer, the treadmill, the stationary bicycle, the elliptical trainer, the swim lap counter, and the global positioning system. The motion may be a distance, a speed, an average speed, work performed, calories, or the like.

The motion may be measured with a sensor. The sensor may be embodied in the fitness device 115, the computing device 110, and/or the first device 105. The sensor may be in an accelerometer, the pedometer, a global positioning system, a gyroscope, or a mobile telephone network.

For example, the accelerometer may determine an average speed of the user as a first derivative of multiple accelerations. The average speed and a time of motion may be used to calculate the motion for the user.

The pedometer may communicate a number of steps to the computing device 110. The accelerometer may also function as the pedometer. For example, the accelerometer may identify a cycle of an acceleration in the first direction followed by an acceleration in an opposite second direction as a step. The motion may be measured in steps. Alternatively, the status may be multiplied by an averaged step distance to generate a distance for the motion.

The global positioning system may measure incremental positions of the user at specified times and calculate the motion from the positions and the times. The gyroscope may detect orientation changes of the user and calculate a dead reckoning change of position for the user. A motion may be calculated from the change of position.

The mobile telephone network may measure changes in signal strength when communicating with one or more mobile telephone base stations. The computing device 110 may estimate a change in position from the changes in signal strength, and determine the motion from the changing position.

In one embodiment, the physical condition is a biometric parameter. The biometric parameter may include but is not limited to a heart rate, a heart rate variability, a glucose level, body mass, blood pressure, galvanic skin response, calories consumed, calories burned, and skin temperature.

In one embodiment, the heart rate measured by one or more of the computing device 110, the fitness device 115, and the first device 105. For example, a mobile telephone computing device 110 may receive a heart rate from a heart rate monitor of a fitness device 115. Alternatively, the mobile telephone computing device 110 may measure the heart rate directly with a microphone.

In one embodiment, one of the computing device 110, the fitness device 115, and the first device 105 measures the heart rate variability. The heart rate variability may be measured by measuring the heart rate at one or more times over a measurement time interval. Alternatively, the heart rate variability may be measured over continuously over the measurement time interval.

The glucose level may be measured using a glucose meter fitness device 115 as will be illustrated hereafter. In one embodiment, the body mass is measured by a scale fitness device 215 and communicated to the computing device 110. Similarly, the blood pressure may be measured by a blood pressure fitness device 115 and communicated to the computing device 110. The galvanic skin response may be measured by a galvanic meter fitness device 115 and communicated to the computing device 110.

In one embodiment, calories consumed are measured using a payment instrument. The payment instrument may be embodied in the computing device 110. For example, the payment instrument may be an electronic wallet embodied in the computing device 110. Alternatively, the payment instrument may be a credit card, and a server for the credit card may be in communication with computing device 110.

The payment instrument may receive the calories consumed from a point-of-sale (POS) device during a transaction with the POS. For example, the POS may communicate total calories for food and beverage items purchased from the POS. In a certain embodiment, the user may identify calories consumed from the total calories.

In an alternate embodiment, a camera of the computing device 110 may record an image of a meal. The computing device 110 may estimate the calories consumed from the image of the meal.

In one embodiment, the calories burned may be measured by the fitness device 115. Alternatively, the computing device 110 may calculate the calories burned from a physical activity. For example, the computing device 110 may calculate the calories burned from activity throughout a day.

The skin temperature may be measured by a thermometer fitness device 115 and communicated to the computing device 110. Alternatively, the skin temperature may be measured by a camera of the computing device 110.

FIG. 1D is a schematic block diagram illustrating one alternate embodiment of an access system 100d. In the depicted system 100d, the computing device 110, the first device 105, and the fitness device 115 are depicted in communication through a network 125. The network 125 may be a mobile telephone network, a WiFi network, a local area network, a wide area network, or combinations thereof. In addition, the computing device 110, the first device 105, and/or the fitness device 115 may be in communication with a server 120 through the network 125.

In one embodiment, the computing device 110, the first device 105, and the fitness device 115 may communicate through the server 120. For example, the server 120 may monitor fitness devices 115 in a fitness facility. A fitness device 115 may communicate a physical condition such as energy expended to the server 120 and the server 120 may communicate the physical condition to the computing device 110.

In one embodiment, the server 120 may set a lock that prevents access to functionality. For example, the server 120 may set a lock that prevents access to a payment instrument. In a certain embodiment, the computing device 110 instructs the server 120 to set the lock.

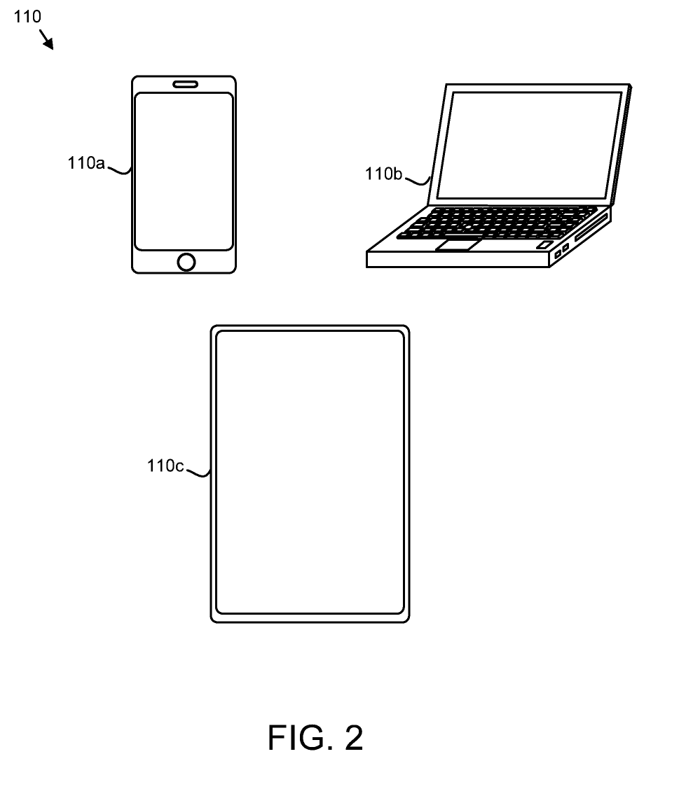

FIG. 2 is a drawing illustrating one embodiments of computing devices 110. The computing device 110 may be a mobile telephone 110a, a tablet computer 110c, a portable computer 110b, and the like. Alternatively, the computing device 110 may be an eyeglass computer, a wearable computer, a wrist computer, a computer workstation, and a server.

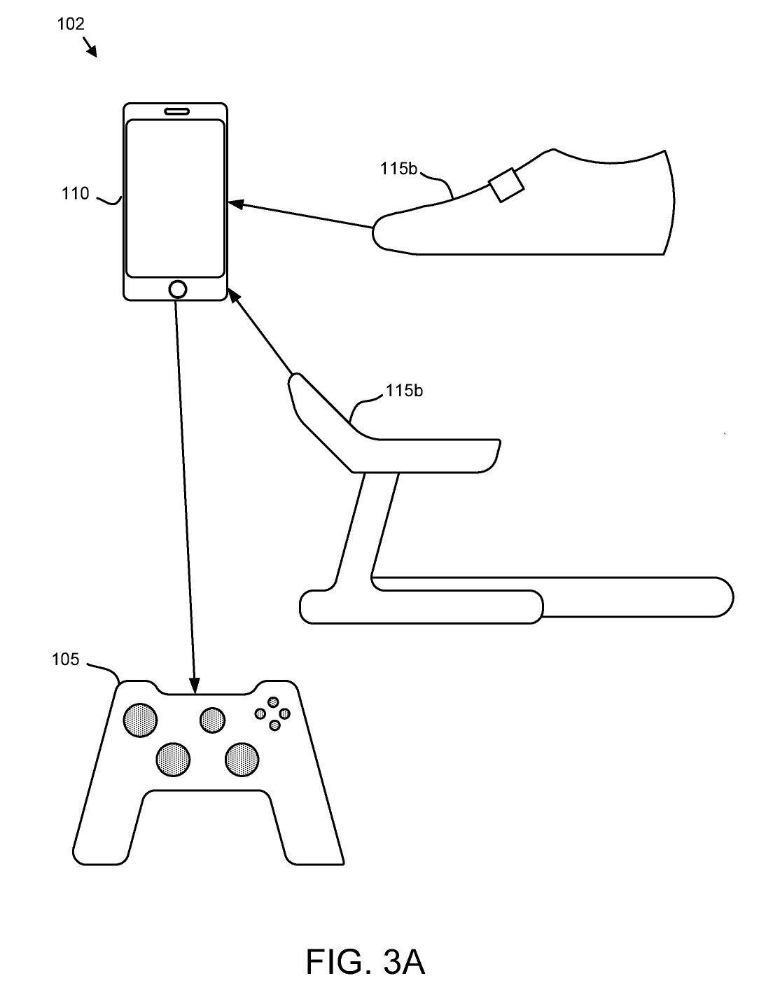

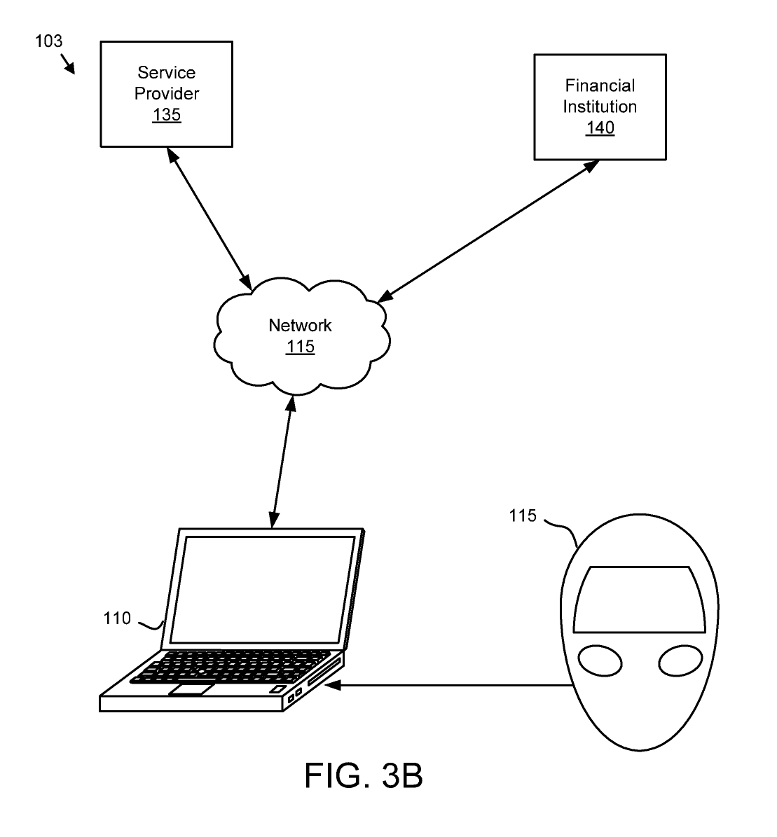

FIG. 3A is a drawing illustrating one embodiment of an access system 102. In the depicted embodiment, the first device 105 is a game console. A virtual lock may be set on the game console to prevent access to functionality of the first device 105. For example, the lock may prevent activating the game console first device 105. Alternatively, the lock may prevent access to a user interface of the first device 105. The computing device 110 may communicate the code through a wired connection and/or a wireless connection to the first device 105 to set the lock.

In the depicted embodiment, the computing device 110 is a mobile telephone. The computing device may be in communication with one or more fitness devices 115 such as a treadmill 115a and/or a shoe 115b. The communication may be through a wireless connection. Alternatively, a wired connection may periodically be established between the computing device 110 and the fitness devices 115.

The fitness devices 115 may measure the physical activity of the user. For example, the treadmill 115a may measure a motion such as the distance ran by the user, calories expended by the user, work performed by the user, the heart rate of the user, and the like. The shoe 115b may measure the steps taken by the user, a motion such as the distance ran by the user, a heart rate of the user, and the like.

The computing device 110 may determine whether a physical condition such as a physical activity exceeds a physical threshold. If the computing device 110 determines that the physical condition exceeds the physical threshold, the computing device 110 may release the lock. In one embodiment, the computing device 110 communicates a specified code through a wired connection and/or a wireless connection to the first device 105 to release the code.

FIG. 3B is a drawing illustrating one alternate embodiment of an access system 103. In the depicted embodiment, the computing device 110 is a portable computer and the fitness device 115 is a glucose meter. The glucose meter fitness device 115 may measure a biomedical parameter physical condition of a glucose level and communicate the glucose level through a USB connection to the computing device 110.

In an alternate embodiment, the physical condition may be a production parameter. The production parameter may include but is not limited to a word count, submitted answers, correct answers to an exam or practice exam, a number of calls placed, a number of emails written, and a number of task completions on a to do list. For example, the computing device 110 may measure a word count of a thesis paper entered into the computing device 110 as the physical condition.

In one embodiment, a service provider 135 is the fitness device 115 measuring the physical condition. For example, the service provider 135 may be a fitness facility. The service provider 135 may record the user patronizing the service provider as the physical condition.

Alternatively, a financial institution 140 may be the fitness device 115. The financial institution 140 may measure the physical condition from purchases. For example, purchases of snacks or purchases recreational activities may be physical conditions. The computing device 110 may value each transaction.

In one embodiment, the computing device 110 may set a lock with the service provider 135 and/or financial institution 140. For example, the service provider 135 may be an online gaming provider and the lock may prevent access to the provider. Alternatively, the financial provider 140 may provide a payment instrument and the lock may prevent use of the payment instrument. In a certain embodiment, the lock may prevent the use of the payment instrument for selected purchases such as unhealthy food and beverages.

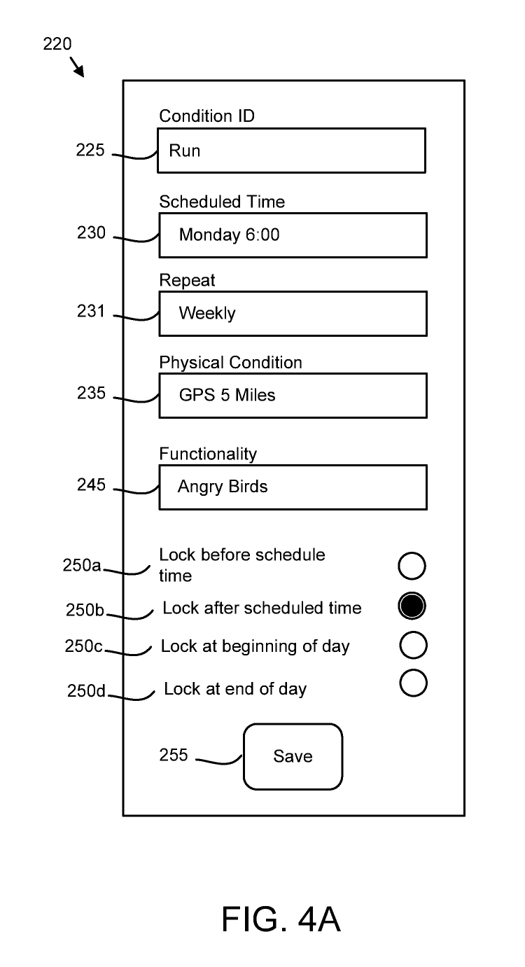

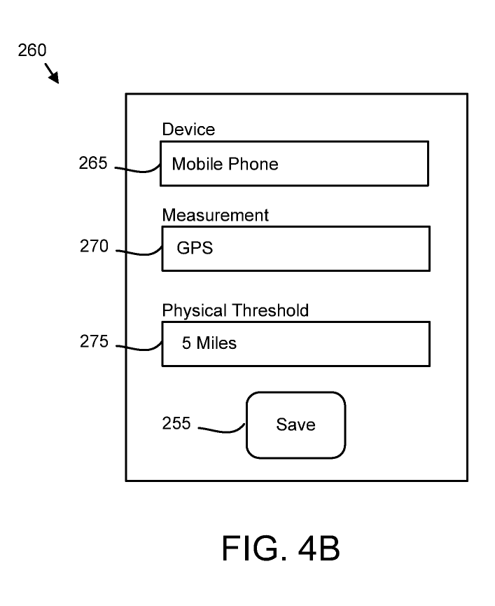

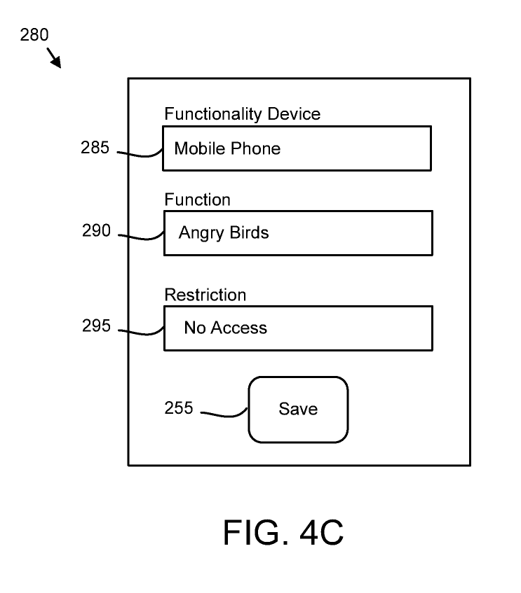

FIG. 4A is a drawing illustrating one embodiment of a physical condition dialog window 220. The window 220 may be displayed on the computing device 110 for creating a schedule of scheduled times when a physical condition is to be completed. The window 220 includes a physical condition identifier 225, a scheduled time 230, a repeat value 231, a physical condition 235, a functionality 245, lock options 250, and the save button 255.

The physical condition identifier 225 may identify the physical condition 235. The physical condition identifier 225 may be descriptive of the physical condition 235. In the depicted embodiment, the physical condition identifier 225 indicates a run. The scheduled time 230 may specify a start time for the physical condition 235. Alternatively, the scheduled time 230 may specify an end time for the physical condition 235. In one embodiment, the scheduled time 230 specifies the time interval for the physical condition 235. In the depicted embodiment, the scheduled time 230 indicates that the run will be on Monday at 6:00.

The repeat value 231 may specify when the scheduled time 230 is repeated. For example, the repeat value 231 may specify that the scheduled time 230 is repeated daily, weekly, or the like. In the depicted embodiment, the repeat value 231 specifies that the physical condition 235 is repeated weekly. The physical condition 235 may detail the physical condition that is to be measured. In the depicted embodiment, the physical condition 235 is traveling 5 miles as measured by a GPS.

The functionality 245 may specify functionality of the computing device 110, the first device 105, a server 120, a service provider 135, a financial institution 140, or the like that may be locked. In the depicted embodiment, the functionality 245 specifies that the functionality that will be locked is a game ANGRY BIRDS®.

The lock options 250 may specify when the functionality 245 is locked relative to the scheduled time 230. In the depicted embodiment, the lock options 250 include locking the functionality 245 before 250a the scheduled time 230 of the physical condition 235, locking the functionality 245 after 250b the scheduled time 230, locking the functionality 245 at the beginning 250c of the day of the scheduled time 230, and locking the functionality at the end 250d of the day of the scheduled time 230. The save button 255 may save the entered values.

FIG. 4B is a drawing illustrating one embodiment of a device dialog window 260. In one embodiment, the device dialog window 260 may be displayed in response to selecting the physical condition 235 in the physical condition dialog window 220. The device dialog window 260 may be displayed on the computing device 110 and may be used to specify how the physical condition 235 is measured.

The device dialog window 260 includes a device 265, a measurement 270, a physical threshold 275, and the save button 255. The device 265 may specify which device measures the physical condition 235. For example, the depicted embodiment, a mobile phone computing device 110 is selected to measure the physical condition 235. The measurement 270 indicates how the device 265 will measure the physical condition 235. The physical threshold 275 must be exceeded by the physical condition 235 to prevent setting the lock or in order to release the lock. In the depicted embodiment, the mobile phone computing device 110 will employ a GPS, and the physical threshold 275 indicates the 5 miles must be measured by the GPS to satisfy the physical condition 235. The save button 255 may save the device turned 65, the measurement and 70, the physical threshold 275.

FIG. 4C is a drawing illustrating one embodiment of a functionality dialog window 280. The functionality dialog window 280 may be displayed on the computing device 110 in response to selecting the functionality 245 in the physical condition dialog window 220. The functionality dialog window 280 includes a functionality device 285, a function 290, and a restriction 295.

The functionality device 285 specifies the device for which the functionality 245 will be locked. In the depicted embodiment, the functionality device 285 is the mobile phone computing device 110. The function 290 may specify which function of the functionality device 285 is locked. The restriction 295 specifies which elements of the function 290 will be locked. In the depicted embodiment, the function of the game ANGRY BIRDS® will be locked by providing no access. The save button 255 may save the functionality device 285, the function 290, and the restriction 295.

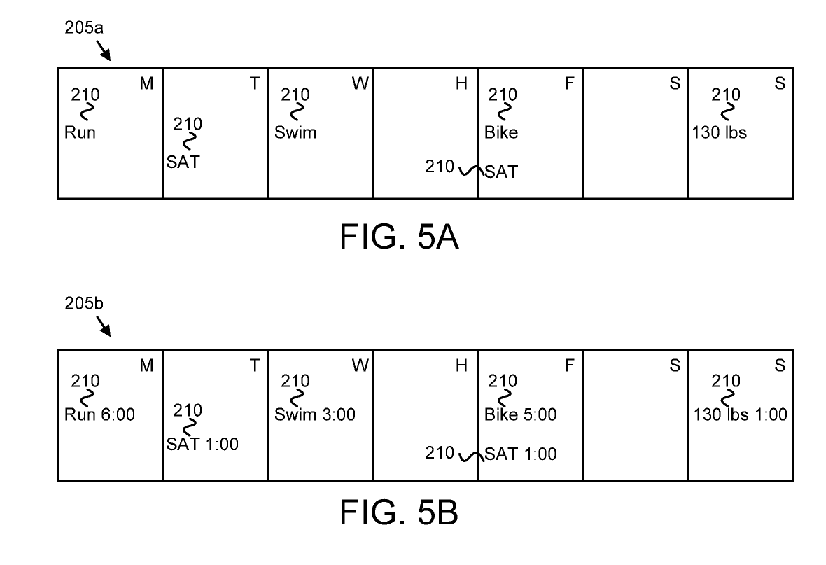

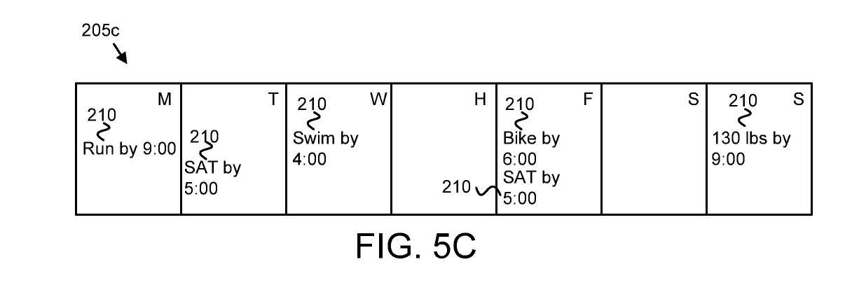

FIG. 5A is a drawing illustrating one embodiment of a schedule 205a. The schedule 205a may be displayed on the computing device 110. The schedule 205a includes one or more physical condition entries 210 for physical conditions 235. In the depicted embodiment, each physical condition entry 210 displays a physical condition identifier 225.

FIG. 5B is a drawing illustrating one alternate embodiment of a schedule 205b. The schedule 205b includes one or more physical condition entries 210. In the depicted embodiment, the physical condition entries 210 display physical condition identifiers 225 and scheduled times 230 for the physical conditions 235. In one embodiment, the schedule times 230 are start times for the physical condition 235. The functionality 245 may be locked at the start time.

FIG. 5C is a drawing illustrating one alternate embodiment of a schedule 205c. In the depicted embodiment, the physical condition entries 210 display a physical condition identifier 225 and schedule times 230 for physical conditions 235. The scheduled times 230 may be end times. The functionality 245 may be locked at an end time.

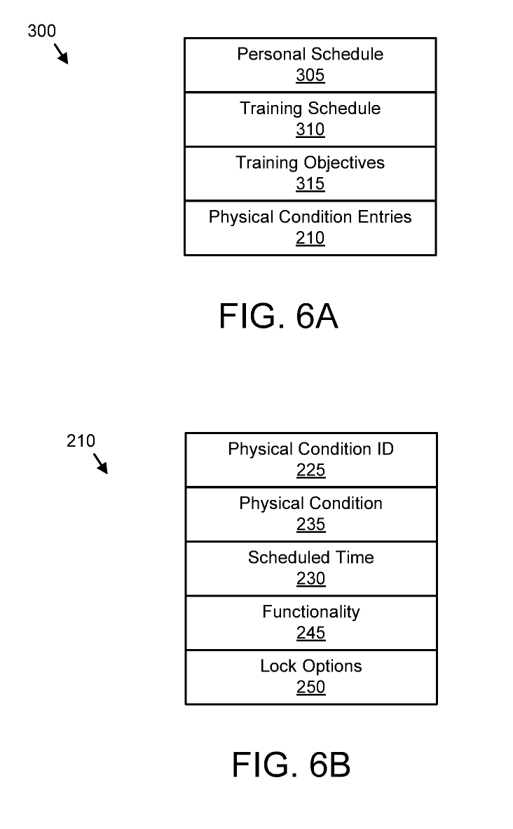

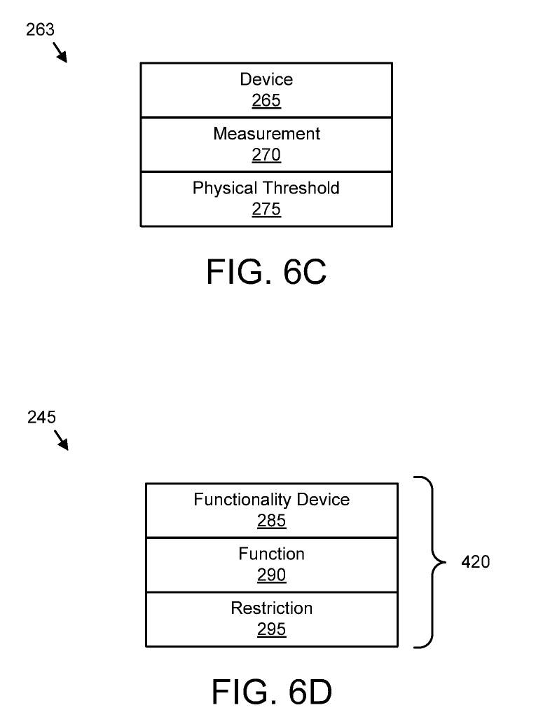

FIG. 6A is a schematic block diagram illustrating one embodiment of a schedule data store 300. The schedule data store 300 may be stored on the computing device 110. The schedule data store 300 may be organized as a database, linked data structures, a flat file, or combinations thereof. The schedule data store 300 may store a personal schedule 305, a training schedule 310, training objectives 315, and physical condition entries 210.

The personal schedule 305 may be a personal schedule of the user. The personal schedule 305 may be imported from one or more calendar applications. The training schedule 310 may be imported from a third party such as a coach, a training website, a training application, or combinations thereof. The training schedule 310 may be a graduated training schedule. For example, the training schedule 310 may be a graduated marathon training schedule from a running coach.

The training objectives 315 may record target performance metrics for the user. The training objects may be for adhering to the training schedule 310. In one embodiment, the training objectives 315 are included in the schedule 205 as physical conditions 235. The physical condition entries 210 records the physical conditions 235 for the schedule 205.

FIG. 6B is a schematic block diagram illustrating one embodiment of physical condition entries 210. The physical condition entries 210 include the physical condition identifier 225, the physical condition 235, the scheduled time 230, the functionality 245, and the lock options 250.

FIG. 6C is a schematic block diagram illustrating one embodiment of a device data store 263. The device data store 263 may be stored in the computing device 110 as one or more database entries, linked data structures, or a flat file. The device data store 263 includes the device 265, the measurement 270, and the physical threshold 275.

FIG. 6D is a schematic block diagram illustrating one embodiment of a functionality data store 245. The functionality data store 245 may be stored in the computing device 110 is one or more database entries, linked data structures, or a flat file. The functionality data store 245 may include the functionality device 285, the function 290, and the restriction 295. In one embodiment, the functionality device to 35, the function 290, and the restriction 295 define a lock 420.

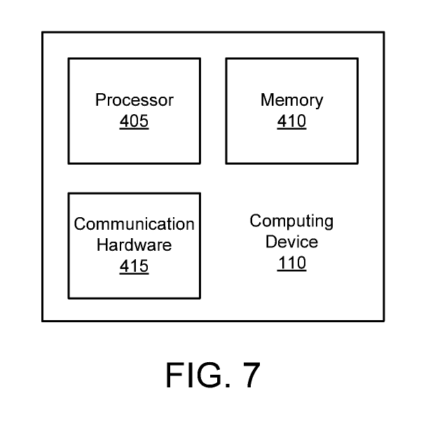

FIG. 7 a schematic block diagram illustrating one embodiment of a computing device 110. The computing device 110 includes a processor 405, a memory 410, and communication hardware 415. The memory 410 may be a non-transitory computer readable storage medium such as a semiconductor storage device, a hard disk drive, a holographic storage device, a micromechanical storage device, or the like. The memory 410 may store computer readable program code. The processor 405 may execute the computer readable program code. The communication hardware 415 may communicate with other devices.

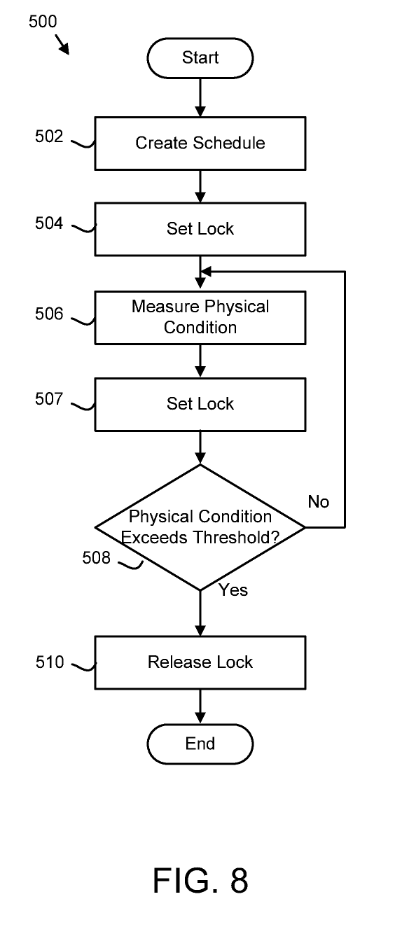

FIG. 8 is a schematic flow chart diagram illustrating one embodiment of an access method 500. The method 500 may perform functions of the access system 100, the first device 105, the computing device 110, and the fitness device 115. The method 500 may be performed by the processor 405. The method 500 may be embodied in a computer readable storage medium such as the memory 410 storing computer readable program code. The program code when executed by the processor 405 may perform the functions of the method 500.

The method 500 starts, and in one embodiment, the computing device 110 creates a schedule 205 of a scheduled time 230 that a physical condition 235 is to be completed by a user. The scheduled time 230 and the physical condition 235 may be entered in the physical condition dialog window 220. In addition, the functionality 245 and the lock options 250 may be entered in the physical condition dialog window 220 to create a physical condition entry 210 that is included in the schedule 205.

The computing device 110 may set 504 a lock 420 that prevents access to functionality 245. In one embodiment, the lock 420 is set 504 by applying the restriction 295 to the function 290 of the functionality device 285. The lock 420 prevents access to the functionality 245. In one embodiment, the lock 420 is set 504 at the scheduled time 230 in response to the physical condition 235 not exceeding the physical threshold 275.

For example, if the physical condition 235 is a run and physical threshold 275 is 5 miles of motion, and if the fitness device 115 and/or computing device 110 measures 4 miles of motion using a GPS, the physical condition 235 does not exceed the physical threshold 275.

In one embodiment, the lock 420 is set 504 prior to the scheduled time 230. The lock 420 may be set 504 at the start time. Alternatively, the lock 420 may be set 504 prior to the scheduled time 230 at a specified time such as the beginning of the day or 6:00 a.m.

In one embodiment, the lock 420 is set 504 at the scheduled time 230 in response to the physical condition 235 not exceeding the physical threshold 275 at a prior scheduled time 230. For example, if the user had scheduled a run physical condition 235 on Monday, and the physical condition 235 did not exceed the physical threshold 275, the computing device 110 may set 504 the lock 420 at the beginning of the day of the subsequent scheduled run physical condition 235. In one embodiment, the computing device 110 sets 504 the lock 420 at the initiation of a coach. The coach may specify when the lock 420 is set 504.

The method 500 further measures 506 the physical condition 235. In one embodiment, a special purpose fitness device 115 measures 506 the physical condition 235. For example, a speedometer fitness device 115 may measure 506 the physical condition 235. Alternatively, a computing device 110 such as a mobile telephone may measure 506 the physical condition 235. In addition, a server 120, the service provider 135, and/or financial institution 140 may measure the physical condition 235.

In one embodiment, the computing device 110 sets 507 the lock 420 to prevent access to the functionality 245. The computing device 110 may set 507 the lock 420 at the scheduled time 230. The lock 420 may be set 507 in response to the physical condition 235 not exceeding the physical threshold 275. The lock 420 may be set 507 subsequent to the scheduled time 230. For example, the lock 420 may be set 504 at the end time, or at the end of the day. In addition, a coach may initiate the setting 507 of the lock 420.

The computing device 110 further determines 508 if the physical condition 235 exceeds the activity threshold 275. If the physical condition 235 exceeds the activity threshold 275, the computing device 110 releases 510 the lock 420 and the method 500 ends. For example, the computing device 110 may release 510 the lock 420 on one or more applications of the computing device 110. Alternatively, the computing device 110 may release 510 the lock by communicating a code to the first device 105.

In one embodiment, a coach may initiate the releasing 510 of the lock 420. In an alternative embodiment, the user may make a monetary payment, such as to the service provider 135 and/or to financial institution 140. The service provider 135 and/or financial institution 140 may acknowledge the monetary payment to the computing device 110 and the computing device 110 may release 510 the lock 420 in response to the monetary payment. Thus a user may release 510 the lock 420 by making the monetary payment.

The embodiments allow a user and/or a third party to create a schedule 205 of scheduled times 230 that a physical condition 235 is to be completed by the user. The embodiments further lock access to functionality 245 until the physical condition 235 exceeds the physical threshold 275. The functionality 245 may be locked before or after the scheduled time 230. When the physical condition 235 exceeds the physical threshold 275, the embodiments release the lock 420. Thus a user's fondness for a particular game application or other desire for access may be used to encourage greater physical activity by the user.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for activity enabled access comprising:
creating, by use of a processor, a schedule of a scheduled time that a physical condition is to be completed by a user;
measuring the physical condition;
setting a lock that prevents access to functionality at the scheduled time in response to the physical condition not exceeding a physical threshold; and
releasing the lock in response to the physical condition exceeding the physical threshold by the scheduled time.

2. The method of claim 1, wherein in the scheduled time is one of a beginning of a first day and an end of the first day.

3. The method of claim 1, wherein the lock is set at the scheduled time in response to the physical condition not exceeding the physical threshold at a prior scheduled time.

4. The method of claim 1, wherein the schedule is imported from a third party.

5. The method of claim 1, wherein the schedule is a graduated training schedule.

6. The method of claim 1, wherein the functionality is for a first device selected from the group consisting of a computing device, a power outlet, a network connection, a game console, a media player, and a physical lock.

7. The method of claim 6, wherein the computing device is selected from the group consisting of a mobile telephone, a tablet computer, a portable computer, a computer workstation, and a server.

8. The method of claim 1, wherein the functionality is selected from the group consisting of an application, an operating system, a device activation, physical access, a logical access, and a payment instrument.

9. The method of claim 8, wherein the payment instrument is selected from the group consisting of a bank account, a pre-paid card, an electronic wallet, a debit card, and a gift card.

10. The method of claim 8, wherein the logical access is an access to a Universal Resource Locator (URL).

11. The method of claim 1, wherein the physical condition is a physical activity selected from the group consisting of a motion, activity on a fitness device, and entrance to a fitness facility.

12. The method of claim 11, wherein the fitness device is selected from the group consisting of a shoe, a bicycle speedometer, a treadmill, a stationary bicycle, an elliptical trainer, a weight machine, a fitness class, a swim lap counter, a heart rate monitor, a global positioning system, a pedometer, and a biometric sensor.

13. The method of claim 11, wherein the motion is measured by a sensor selected from the group consisting of an accelerometer, a pedometer, a global positioning system, a gyroscope, and a mobile telephone network.

14. The method of claim 11, wherein the physical activity is measured at a fitness device and communicated to a computing device.

15. The method of claim 11, wherein the physical activity is measured at a first device and the lock prevents access to functionality on the first device.

16. The method of claim 1, wherein the physical condition is a biomedical parameter selected from the group consisting of a heart rate, a heart rate variability, glucose levels, body mass, blood pressure, galvanic skin response, calories consumed, calories burned, and skin temperature.

17. The method of claim 1, wherein the physical condition is production parameter selected from the group consisting of a word count, submitted answers, correct answers, a number of calls, a number of emails, and a number of task completions.

18. The method of claim 1, wherein the lock is released in response to a monetary payment.

19. The method of claim 1, wherein a coach initiates one or more of setting the lock and releasing the lock.

20. A computer program product comprising a non-transitory computer readable storage medium storing computer readable code executable by a processor to perform:
creating a schedule of a scheduled time that a physical condition is to be completed by a user;
measuring the physical condition;
setting a lock that prevents access to functionality at the scheduled time in response to the physical condition not exceeding a physical threshold; and
releasing the lock in response to the physical condition exceeding the physical threshold by the scheduled time.
